(19) United States
(12) Patent Application Publication
(10) Pub. No.: US 2007/0130867 A1
(43) Pub. Date: Jun. 14, 2007

(54) Barrier panel

(76) Inventor: Kelly Ray Flaherty, Braselton, GA (US)

Correspondence Address: Carlos Nieves, Esq.;J.M. Huber Corporation, 333 Thornall Street, Edison, NJ, 08837-2220, US

(21) Appl. No.: 11/287,639

(22) Filed: Nov. 28, 2005

(51) Int. Cl. E04B 2/56; B32B 7/12; B32B 21/06; B32B 21/08

(52) U.S. Cl. 52/483.1; 428/107

(57) ABSTRACT

Disclosed is a panel comprising: a liquid-impermeable, moisture-permeable film layer, and an underlying wood board.

### BACKGROUND OF THE INVENTION

The walls of a residential or commercial building are typically constructed by attaching several panels to the studs of an underlying supporting structural frame; the panels are placed edge-to-edge with each panel contacting the edges of adjacent panels. An additional layer, known as a water-resistive barrier, is then wrapped and secured to the wall panels. Common water-resistive barrier materials include building paper, asphalt felt and a variety of polymeric “housewraps”. One popular material for this purpose is the Tyvek® product available from the Dupont Corporation, Wilmington, Del.

Constructing a wall in this manner has the advantage of requiring the efforts of only a few workers at a time, and the use of this barrier material “house wrap” provides additional protection by protecting the wall from moisture penetration and additionally reduces the air loss from infiltration. However, while this provides additional protection against water penetration, it has the disadvantage of being difficult and time-consuming to install because the paper or wrap must be first unrolled and spread over the wall surface and then secured to those panels. If this wall wrap paper were attached to the wall panels during manufacture then the additional step of attaching the wrapping paper to the panels after the installation of the panels could be avoided along with the occasional need to reinstall or reattach the wall wrap paper when it is damaged during construction by inclement weather.

Accordingly, panels have been developed with the wall wrapping barrier material preapplied during manufacture. Such panels are available under the Zip® trademark from Huber Engineered Woods, Charlotte, N.C.

However, there are difficulties in these prior art house wrap products: they are applied using fasteners which can cause air and water leakage, and the seams in the house wrap material are often (˜50%) not taped so that undesired air loss and water penetration can occur.

Given the foregoing, there is a continuing need to develop panels for wall construction that have an additional protective layer especially to prevent the penetration of liquid water into panels and at panel seams where adjacent wall panels join; and additionally at the same time are sufficiently vapor moisture permeable so as to allow water vapor to evaporate out of the wall cavities.

### BRIEF SUMMARY OF THE INVENTION

The present invention relates to a panel comprising a liquid-impermeable, moisture-permeable film layer, and an underlying wood board.

The present invention also relates to a construction for a building comprising: a frame structure; and a plurality of panels attached to the frame structure, each panel comprising a liquid water-impermeable moisture-permeable film layer, adhered to an underlying wood board.

### DETAILED DESCRIPTION OF THE INVENTION

All parts, percentages and ratios used herein are expressed by weight unless otherwise specified. All documents cited herein are incorporated by reference.

As used herein, “wood” is intended to mean a cellular structure, having cell walls composed of cellulose and hemicellulose fibers bonded together by lignin polymer.

By “wood composite material” it is meant a composite material that comprises wood and one or more other additives, such as adhesives or waxes. Non-limiting examples of wood composite materials include oriented strand board (“OSB”), waferboard, particle board, chipboard, medium-density fiberboard, plywood, and boards that are a composite of strands and ply veneers. As used herein, “flakes”, “strands”, and “wafers” are considered equivalent to one another and are used interchangeably. A non-exclusive description of wood composite materials may be found in the Supplement Volume to the Kirk-Othmer Encyclopedia of Chemical Technology, pp 765-810, 6^{th} Edition.

The following describes preferred embodiments of the present invention which provides a panel, attached to the studs of a timber frame structure to form walls, and is suitable for use in the construction of residential and commercial buildings. To provide additional protection against water penetration, particularly where adjacent panels meet to form a seam, a water resistant film layer (preferably self-adhesive) is applied. Because the water resistant barrier layer is attached to the wall panels during manufacture, the additional step of applying the barrier layer over the panels during construction of the wall is avoided. When the protective film layer is self-adhesive, there is no need for separate steps of applying the protective film layer along with an accompanying adhesive. Optionally, the panels prepared according to the present invention may also have a water resistant barrier layer.

(It should be noted that although the present invention will be described with respect to walls, the panels of the present invention could also be used to construct roofs. The modifications that would be necessary to adapt the inventive wall panel for use as a roof panel are well-known to those of ordinary skill in the art.)

The three components of the present invention, the optional water resistant barrier layer, the film layer, and the underlying wood board will now be described in greater detail.

The barrier layer is selected from a suitable material that provides adequate protection against the penetration of liquid water. Some materials (particularly certain coatings) may also provide additional protection against ultraviolet light.

The barrier layer is preferably selected from high and medium-density overlay materials, such as high-density overlay materials, which are typically resin-impregnated crèpe paper, and medium-density overlay materials, which are resin-impregnated kraft paper. These overlays are made by saturating a kraft or crèpe paper with a thermosetting resin (such as phenolic resin) and then curing the resin. Suitable high and medium-density overlays are disclosed in U.S. Pat. No. 5,116,446, issued May 26, 1992, to Cannon, and U.S. Pat. No. 5,089,348, issued Feb. 18, 1992, to Louderback. Preferably the high and medium-density overlay material (such as kraft paper) has a weight of about 25 lbs./msf to about 75 lbs./msf and a resin content of about 1% to about 60%, preferably 20% to about 60% by dry weight.

The barrier layer may also include other additives, such as pigments and binders. Suitable binders include acrylamides, starches, urea resins, phenol resins, sodium silicates, epoxy resins, as well as other polymers.

The film layer includes a liquid water-impermeable and moisture vapor-permeable film. Preferably this liquid water-impermeable and moisture vapor-permeable film is combined with a liquid water-impermeable and moisture-vapor permeable adhesive to make the overall film layer self-adhesive as well as moisture vapor-permeable and liquid water-impermeable. By selecting film and adhesives that are both water-impermeable and moisture-vapor permeable, most liquid water is prevented from penetrating into the wall panel, and of the liquid water which does penetrate can be eliminated because the moisture-vapor permeable characteristics of the film allows water to pass through and thereby evaporate out of the wall cavities.

The liquid water-impermeable and moisture vapor-permeable film is preferably made from polyurethane film, which may include aromatic or aliphatic isocyanate components as well as ether or ester-based polyol components, while the liquid water-impermeable and moisture vapor-permeable adhesive is preferably acrylic. Other useful materials for the film material include polyether-block amides, and block-copolymers of polybutylene-terephtalate and polyetherglycols.

Alternatively, the film layer does not include an adhesive component and is not self-adhering. Instead adhesive may be separately applied to the surface to which the film is to be applied, or instead adhesive may be dispensed with altogether and the film layer applied at elevated temperature and pressure without adhesive.

The film layer will have a thickness of about 0.0005″ to about 0.025″, and a moisture vapor transmission rate (as determined by ASTM E 96/96B-05, Procedure B) of about 7 g/m²/day to about 1400 g/m²/day. A suitable commercial specimen of the film layer is the 9841 tape product available from 3M Corporation, St. Paul, Minn. As used herein, “liquid water-impermeable” means that the film passes the CCMC 0712 1-inch water ponding test without leaking and “moisture-vapor permeable” means that the permeability is greater than about 7 g/m²/day (again as measured by ASTM E 96/96B-05, Procedure B).

The underlying wood board substrate in the present invention may be made from a variety of different materials, such as wood or wood composite materials, such as oriented strand board (“OSB”), which is particularly preferred. Methods for making OSB, wood, and wood composite materials are well-known in the art.

Finally all of these components are brought together in a secondary assembly process to form the wall panel. (The wall panel may also be manufactured in a less-preferred primary process). In the secondary assembly process, the film layer and the wood panel are manufactured separately and then connected to each other. The self-adhesive film layer is applied to the panel, preferably under elevated temperature and pressure, by a nip-roller, platens, or other method appropriate for application of the barrier material to the surface of the panel. The self-adhesive film layer may be applied at ambient temperature and pressure, or alternatively elevated pressures and temperatures may be used if deemed necessary. Suitable application temperatures are in the range of 60° F. to 250° F. while suitable application pressures are in the range of 0.5 psi to 800 psi, (more specifically pressures of 0.5 pounds per inch (“pli”) to 100 pli with a nip roller or 5 psi to 600 psi with a platen press).

(In the less-preferred primary process, resin-coated strands are spread on a conveyor belt in one or more layers, and the film layer is then applied on top of the coated strands and compressed under a hot press machine that fuses and binds together the film layer, the wood materials, binder, and other additives to form consolidated engineered wood panels.)

In one alternative to the use of self-adhesive film, the barrier layer film can also be applied to the panel without an adhesive by the use of heat and pressure in a secondary process (primary is less preferred). Suitable temperatures and pressures for this process are approximately 190° C. and up to 800 psi.

Additionally, the adhesive and film layer film can be applied separately. The adhesive would be applied to the surface of the underlying wood board using standard methods and equipment, such as a roll coater, reverse-roll coater, air knife coater, or other such suitable equipment followed by application of the film under heat and/or pressure.

An optional barrier layer selected from high and medium-density overlay materials may also be attached. The optional barrier layer may be applied in a secondary process, wherein the wood panel is manufactured as a first step, and then as a second step a laminating press consolidates the resin impregnated kraft paper overlay onto the OSB substrate. This laminating typically occurs at a temperature and pressure of about 200° F. to about 600° F., and 100 psi to 1000 psi, respectively. Finally, the aforementioned film layer is applied onto the barrier layer.

The panels disclosed in the present invention will be attached to the studs in a conventional frame structure to form walls. However, as mentioned above, the panels of the present invention could also be used to construct roofs. For example, a roof may be constructed by attaching several of the panels of the present invention to the rafters of an underlying supporting structural frame; preferably the panels are placed in a quilt-like pattern with the edge of each panel contacting the edges of adjacent panels. Whether being used to form walls or roofs, joints are formed between the adjacent panels. In order to prevent the penetration of water through these seams, the film and barrier layer of the present invention may be applied as a combination over the joints.

The invention will now be described in more detail with respect to the following, specific, non-limiting examples.

### EXAMPLE 1

A permeable polyurethane film tape film was applied to portions of wall panels according to the present invention, starting with 7/16″ thick OSB having a density of 42 Pcf. Tape consisting of a polyurethane backing and acrylic adhesive (number 9841 made by 3M) was peeled from its backing and applied to portions of the OSB surface using hand pressure, while other portions of the OSB surface remaining unprotected. The tape stuck well to the surface.

### EXAMPLE 2

A permeable polyurethane tape/film was applied to portions of wall panels prepared according to the present invention, starting with 7/16″ thick OSB having a density of 42 Pcf, with a resin-impregnated kraft paper overlay having a base paper weight of 31 lb/1000 sq. ft., a treated paper weight of 57.5 lbs/1000 sq. ft., a paper resin content of 35% and a gluecoat weight of 9.5 lbs/1000 sq. ft. A tape (number 9841 made by 3M) was peeled from its backing and applied to portions of the kraft paper layer, with pressure applied to the surface by hand. The tape stuck well to the surface. The tape was applied to portions of the kraft paper, while other portions of the kraft paper remained unprotected.

### EXAMPLE 3

The barrier layer film can also be applied to the panel without the use of an adhesive layer by the use of heat and pressure in a secondary process (primary is possible). Temperatures used were 190° C. and pressures were up to 800 psi. The film was applied to panels with and without the overlay paper with adequate adhesion.

Wall panel samples prepared according to example 1 and 2 above were immersed in an aqueous dark blue dye solution for two hours. After two hours, the samples were removed from the dye solution. The portions of the unprotected (kraft paper or panel) surface had a slight blue stain, showing liquid water penetration. However, portions of the kraft paper or panel surface that were covered with the polyurethane film tape were not dyed, showing that protection of the surface was occurring.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A panel comprising: a liquid-impermeable, moisture-permeable film layer, and an underlying wood board.

2. The panel according to claim 1, further comprising a resin-impregnated, water-resistant barrier layer.

3. The panel according to claim 2, wherein the resin-impregnated, water-resistant barrier layer is composed of a resin-impregnated kraft paper.

4. The panel according to claim 1, wherein the moisture-permeable film layer has a moisture vapor transmission rate of about 7 g/m²/day to about 1400 g/m²/day.

5. The panel according to claim 1, wherein the underlying wood board is an OSB.

6. The panel according to claim 1, wherein the film layer is self-adhesive.

7. The panel according to claim 6, wherein the film layer is composed of a polymer film.

8. The panel according to claim 6, wherein the film layer is composed of a polymer film and an acrylic adhesive.

9. The panel according to claim 8, wherein the film layer is composed of a polymer selected from the group consisting of polyurethane, polyether-block amides, and block-copolymers of polybutylene-terephtalate and polyetherglycols.

10. The panel according to claim 1, wherein the film layer is adhered to the wood board.

11. A construction for a building comprising:
a frame structure; and
a plurality of panels attached to the frame structure, each panel comprising a liquid water-impermeable moisture-permeable film layer, adhered to an underlying wood board.
